(19) United States
(12) Patent Application Publication
(10) Pub. No.: US 2013/0233613 A1
(43) Pub. Date: Sep. 12, 2013

(54) CONDENSER-TYPE HIGH-VOLTAGE BUSHING AND METHOD FOR PRODUCING THE BUSHING

(71) Applicant: SIEMENS AKTIENGESELLSCHAFT, Muenchen (DE)

(72) Inventors: MICHAEL KOCH, KOELN (DE); ACHIM LANGENS, LOHMAR (DE); TIM SCHNITZLER, KREUZAU (DE)

(73) Assignee: SIEMENS AKTIENGESELLSCHAFT, MUENCHEN (DE)

(21) Appl. No.: 13/790,116

(22) Filed: Mar. 8, 2013

(30) Foreign Application Priority Data
Mar. 8, 2012 (DE) 10 2012 203 705.5

(51) Int. Cl. H02G 3/22; H02G 1/00

(52) U.S. Cl. CPC H02G 3/22; H02G 1/00
USPC 174/650; 29/887

(57) ABSTRACT

A condenser-type high-voltage bushing has a cast-resin-impregnated core formed of wound paper, onto which silicone shields have been applied. The high-voltage bushing is further improved with regard to its design and manufacture in such a way that said high-voltage bushing in the long term meets the electrical requirements to which it is subjected. For that purpose, the wound core bears a vapor-tight cover layer on the outside and the silicone shields are applied on the cover layer.

### CROSS-REFERENCE TO RELATED APPLICATION

This application claims the priority, under 35 U.S.C. § 119, of German patent application DE 10 2012 203 705.5, filed Mar. 8, 2012; the prior application is herewith incorporated by reference in its entirety.

### BACKGROUND OF THE INVENTION

### Field of the Invention

The invention relates to a condenser-type bushing, also referred to as capacitor-controlled high-voltage pass-through bushing, comprising a cast-resin-impregnated coil former consisting of paper, onto which silicone shields have been applied directly.

A bushing of this type is known from the book by Andreas Küchler, “Hochspannungstechnik” [High-Voltage Engineering], 2nd edition, 2003, pages 439-440. In the case of the prior known high-voltage bushing, the silicone shields are vulcanized directly onto the cast-resin-insulated coil former.

### SUMMARY OF THE INVENTION

It is an object of the invention to provide a method and a pass-through bushing for high-voltage applications which overcome a variety of disadvantages of the heretofore-known devices and methods of this general type and which provides for an improved high-voltage bushing that is simple in terms of design and manufacture yet it meets the long term electrical requirements to which it is subject.

With the foregoing and other objects in view there is provided, in accordance with the invention, a condenser-type high-voltage bushing, comprising:
a cast-resin-impregnated wound core formed of paper and bearing a vapor-tight cover layer on an outside; and
silicone shields applied directly on said vapor-tight cover layer of the cast-resin-impregnated wound core.

In other words, the objects of the invention are achieved with a condenser-type high-voltage bushing of the type mentioned above which has a vapor-tight cover layer born on the outside of the wound core.

A substantial advantage of the high-voltage bushing according to the invention consists in that, owing to the vapor-tight cover layer, the coil former remains dry because no moisture can diffuse into the coil former through such a cover layer. In this case, this cover layer can be produced in a simple manner because it can simply be applied to the coil former on the outside once the actual coil former has been produced.

In the case of the high-voltage bushing according to the invention, the cover layer can be formed in a variety of ways. It is particularly advantageous if the cover layer consists of at least one turn of a vapor-tight web material because in this case the cover layer can be produced with the same manufacturing device which was also used for the manufacture of the coil former itself.

Secondly, it may also be advantageous if the cover layer consists of an applied compound with vapor-tight properties.

The invention also relates to a method for producing a condenser-type, or capacitor-controlled, high-voltage bushing comprising a cast-resin-impregnated coil former consisting of paper, onto which silicone shields have been applied directly.

In order to be able to configure a condenser-type high-voltage bushing using such a method in a simple manner in such a way that said capacitor-controlled high-voltage bushing in the long term meets the electrical requirements to which it is subject, according to the invention the wound core is provided with a vapor-tight cover layer on the outside prior to the application of the silicone shields.

This manufacturing step does not involve any notable additional complexity, but has the result that, owing to the vapor-tight cover layer, the coil former remains dry because no moisture can diffuse into the wound core through such a cover layer. The dielectric strength is therefore permanently ensured.

In the method according to the invention, the cover layer can be formed in a particularly simple manner in terms of manufacturing technology from at least one turn of a vapor-tight web material. Under some circumstances, however, it may be advantageous to produce the cover layer from an applied compound with vapor-tight properties.

Other features which are considered as characteristic for the invention are set forth in the appended claims.

Although the invention is illustrated and described herein as embodied in a capacitor-controlled high-voltage bushing and method for producing same, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a side elevation of an exemplary embodiment of the condenser-type high-voltage bushing according to the invention; and

FIG. 2 shows a detail of the high-voltage bushing shown in FIG. 1.

### DETAILED DESCRIPTION OF THE INVENTION

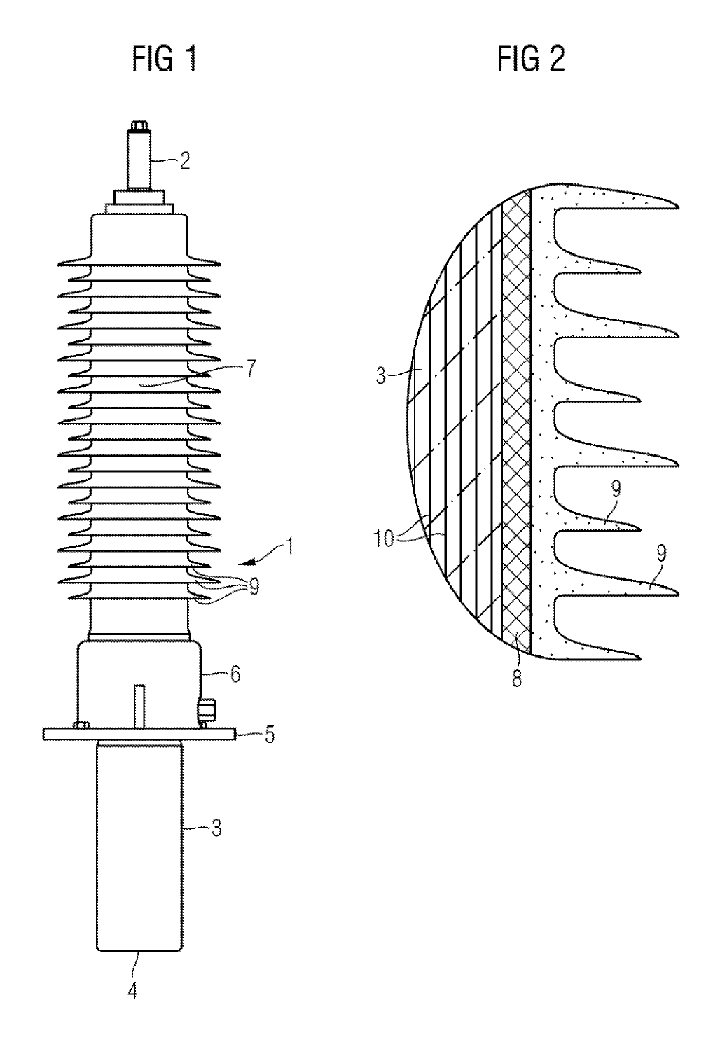

Referring now to the figures of the drawing in detail and first, particularly, to FIG. 1 thereof, there is shown a condenser-type, or capacitor-controlled, high-voltage pass-through bushing 1 that is suitable to provide an electrical transition from a transformer to an outdoor high-voltage connection 2. The high-voltage bushing 1 has a cast-resin-impregnated wound core 3 consisting of paper, which extends from its transformer-side (lower in FIG. 1) end 4 out through a bearing flange 5 towards the outdoor high-voltage connection 2. A ring-shaped housing part 6 is disposed on the bearing flange 5 and the outdoor-side part 7 of the condenser-type high-voltage bushing 1 is disposed on the ring-shaped housing part 6.

Referring now to FIG. 2, the core 3 is provided with a vapor-tight cover layer 8 on the outside. Silicone shields 9 are applied or vulcanized directly onto the, otherwise complete, high-voltage bushing 1.

As already noted above, the high-voltage bushing 1 has been wound from paper. Conductive inserts 10 have also been wound into the paper layers in a known manner during the winding process in order to form the capacitor-controlled high-voltage bushing 1. The core 3 thus formed is impregnated with cast resin.

1. A condenser-type high-voltage bushing, comprising:
a cast-resin-impregnated core formed of paper and bearing a vapor-tight cover layer on an outside; and
silicone shields applied directly on said vapor-tight cover layer of said cast-resin-impregnated core.

2. The high-voltage bushing according to claim 1, wherein said cover layer consists of at least one turn of a vapor-tight web material.

3. The high-voltage bushing according to claim 1, wherein said cover layer consists of a compound with vapor-tight properties applied on said core.

4. A method of producing a condenser-type high-voltage bushing, the method which comprises:
winding a cast-resin-impregnated core with paper;
placing a vapor-tight cover layer on an outside of said cast-resin-impregnated core; and
subsequently applying silicone shields directly on the vapor-tight cover layer.

5. The method according to claim 4, which comprises forming the cover layer from at least one turn of a vapor-tight web material.

6. The method according to claim 4, which comprises producing the cover layer from an applied compound with vapor-tight properties.
